(19) United States
(12) Patent Application Publication
(10) Pub. No.: US 2023/0376998 A1
(43) Pub. Date: Nov. 23, 2023

(54) FACILITATING NETWORK-BASED DISCOVERY AND INTERACTION

(71) Applicant: Cyber Secure Mobile Payments, Inc., Nashville, TN (US)

(72) Inventors: Scott M. Pranger, Nashville, TN (US); Cory D. Raines, Nashville, TN (US)

(21) Appl. No.: 18/320,534

(22) Filed: May 19, 2023

Related U.S. Application Data
(60) Provisional application No. 63/344,271, filed on May 20, 2022.

(51) Int. Cl. G06Q 30/0251; H04L 9/32

(52) U.S. Cl. CPC G06Q 30/0252; H04L 9/3213

(57) ABSTRACT

A computing device can receive a geolocation from a client device. The geolocation can correspond to a location of the client device. The computing device can identify an event within a predetermined distance from the geolocation. The computing device can send a list of events comprising the event to the client device. The computing device can determine a promotion associated with the event and at least one condition associated with the promotion. The computing device can determine that the client device satisfies the at least one condition associated with the promotion. The computing device can transfer an award for the promotion to a user account corresponding to the client device in response to determining that the client device satisfies the at least one condition.

### CROSS-REFERENCE TO RELATED APPLICATIONS

This application claims the benefit of and priority to U.S. Provisional Patent Application No. 63/344,271, entitled “SYSTEMS AND METHODS FOR FACILITATING DISCOVERY AND INTERACTION BETWEEN ENTERTAINMENT PROVIDERS AND THEIR PATRONS,” filed May 20, 2022, the entire contents and substance of which is incorporated herein by reference as if fully set forth below

### TECHNICAL FIELD

The present systems and processes relate generally to an infrastructure for facilitating interactions between entertainment providers and their patrons.

### BACKGROUND

Musicians and other live performers are limited by the quantity of channels and networks available for increasing performance exposure, building a following, driving fan engagement, and managing income from performances. On the patron end, there may be advertisements for discovering local events or for supporting entertainment providers, but these are limited in reach. The payment portals may offer the ability for patrons to send money to entertainers but those portals rely on a one way channel of transaction. For example, the patron may provide a certain amount of money, either upfront or in a monthly subscription, and in turn the entertainer may provide access to exclusive content. There is currently no system that facilitates monetary exchanges for patrons engaging with an entertainer. Additionally, patrons do not have easy access to a network where they can both discover and support live entertainers using a comprehensive system.

Therefore, there is a long-felt but unresolved need for a system or method that provides entertainers and patrons a consolidated platform for discovering events, providing benefits to patrons, increasing exposure for entertainers, facilitating income management for entertainers, and driving fan engagement.

### BRIEF SUMMARY OF DISCLOSURE

In various embodiments, the present disclosure relates to systems and methods for a platform that optimizes and facilitates connecting patrons of events to performers of said events. In at least one embodiment, the present system includes a performer application (also referred to as a “StaksMusicians application”). The performer application can provide a platform where musicians, artists, athletes, and other live event entertainment providers, herein referred to as performers, can schedule their upcoming live performances, automate processing and division of income and tips from performances, and recognize their loyal patrons through various programs.

In at least one embodiment, the present system can include a patron application (also referred to as a “StaksPay application”). The patron application and the performer application can be combined as one application or separated into two distinct applications. For example, the patron application and the performer application can be two portals within one application. In another example, the patron application and the performer application can be two individual applications using the same computing infrastructure to communicate and perform actions.

A patron device of a particular patron can install the patron application. The patron application, amongst other features, can be used to discover performances within a default five mile radius. For example, a performer application can publicize a list of performances at specific locations. Continuing this example, the patron application can receive the list of performances with their corresponding locations from the performer application and can display a subset of the performances within a five mile radius from the patron device.

The patron application can receive credit card or bank account information and link the information to a blockchain-enabled patron wallet (also referred to as “MyWallet”) for a particular patron. The patron wallet can enable easy tipping to performers at any particular type of live event. The performer application can include a performer wallet to receive tips and other payments sent by a particular patron through the patron application. The performer wallet can be substantially similar to the patron wallet. In certain embodiments, the performer application can automatically divide received income between the performers of a particular group, if there are more than one, using any particular preprogramed division ratio.

On creating an account through the performer application, performers can receive a particular amount of cryptographic tokens deposited in their respective performer wallet. In particular embodiments, the cryptographic token is referred to herein as “StaksCoin” and can be defined as a mechanism for exchanging a particular cryptographic currency. The performer application can distribute the StaksCoin to any particular patron. For example, the performer application can send StaksCoin to the patron wallet of a particular patron if the patron meets a particular threshold. Thresholds can include, but are not limited to, top listeners of a particular performer, top attendees of a particular performer, engaged patrons of a particular performer, and a certain amount of merchandise acquired from the performer. The performer can employ the performer application to set any particular conditions that can trigger sending StaksCoin to the patron wallets of particular patrons. In some embodiments, the StaksCoin can include inherent value that varies based on demand. In at least one embodiment, the patron application can provide a Staks marketplace, where patrons can spend their StaksCoin.

In at least one embodiments, the performer application and the patron application can communicate with a centralized computing environment. The computing environment can manage any particular computing requirements of the patron application, the performer application, and any other particular application of the ecosystem. For example, the computing environment can manage accounts created by performers, accounts created by patrons, patron wallets of patrons, performer wallets of performers, StaksCoin of performers and patrons, data analytics for performers, communication networks between patrons and performers, event listings received by the performer applications, geolocation services for identifying events in real-time, transactions performed between patron applications and performer applications, and any other particular service discussed in further detail herein.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment.

FIG. 1 illustrates a networked environment according to various embodiments of the present disclosure.

FIG. 2 illustrates a workflow for one or more event registrations according to various embodiments of the present disclosure.

FIG. 3 illustrates a workflow for event discovery and facilitating positive interactions between patrons and performers according to various embodiments of the present disclosure.

FIG. 4 illustrates a workflow for engaging with patrons through the networked environment according to various embodiments of the present disclosure.

FIG. 5 illustrates a workflow showing various features of the patron application according to various embodiments of the present disclosure.

FIG. 6 illustrates a flowchart for a process according to various embodiments of the present disclosure.

### DETAILED DESCRIPTION

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for a platform that optimizes and facilitates connecting patrons of events to performers of said events. In at least one embodiment, the present system includes a networked environment. The networked environment can include a computing environment, one or more patron devices, one or more performer devices, and a blockchain infrastructure all communicating over a network. The patron device can include any particular electronic device that can download a patron application (also referred to as a “StaksPay application”). The performer device can include any particular electronic device that can download a performer application (also referred to as a “StaksMusicians application”). The performer application can provide a platform where musicians, artists, athletes, and other live event entertainment providers, herein referred to as performers, can schedule their upcoming live performances, automate processing and division of income and tips from performances, and recognize their loyal patrons through various programs. The patron application can identify various live events in the vicinity of the patron device, allow patrons the ability to interact with performers, and provide a socialized platform for patrons attending a particular event.

The patron application and the performer application can be combined as one application or separated into two distinct applications. For example, the patron application and the performer application can be two portals within one application. In another example, the patron application and the performer application can be two individual applications using the same computing infrastructure to communicate and perform actions.

The patron application can discover performances within a default five mile radius. For example, a performer application can publicize a list of performances at specific locations. Continuing this example, the patron application can receive the list of performances with their corresponding locations from the performer application and can display a subset of the performances within a five mile radius from the patron device. The patron application can facilitate communications between patrons and performers. For example, the patron application can send the performer application one or more song requests during a live event. In another example, the patron application can send the performer application a private or public review of the performance.

The patron application can receive credit card or bank account information and link the information to a blockchain-enabled patron wallet (also referred to as “MyWallet”) for a particular patron. The patron wallet can be integrated into the patron application and into the patron device. For example, each patron wallet can be device specific and can be stored locally onto the patron device. The patron wallet can enable easy tipping to performers at any particular type of live event. The performer application can include a performer wallet to receive tips and other payments sent by a particular patron through the patron application. The performer wallet can be substantially similar to the patron wallet. In certain embodiments, the performer application can automatically divide received income between the performers of a particular group, if there are more than one, using any particular preprogramed division ratio.

On creating an account through the performer application, performers can receive a particular amount of cryptographic tokens deposited in their respective performer wallet. In particular embodiments, the cryptographic token is referred to herein as “StaksCoin” and can function as a mechanism to exchange a cryptographic currency. The performer application can distribute the StaksCoin to any particular patron. For example, the performer application can send StaksCoin to the patron wallet of a particular patron if the patron meets a particular threshold. Thresholds can include, but are not limited to, top listeners of a particular performer, top attendees of a particular performer, engaged patrons of a particular performer, and a certain amount of merchandise acquired from the performer. The performer can employ the performer application to set any particular conditions that can trigger sending StaksCoin to the patron wallets of particular patrons. In some embodiments, the StaksCoin can include inherent value that varies based on demand. In at least one embodiment, the patron application can provide a Staks marketplace, where patrons can spend their StaksCoin.

In at least one embodiments, the performer application and the patron application can communicate with the computing environment over the network. The computing environment can manage any particular computing requirements of the patron application, the performer application, and any other particular application of the ecosystem. For example, the computing environment can manage accounts created by performers, accounts created by patrons, patron wallets of patrons, performer wallets of performers, StaksCoin of performers and patrons, data analytics for performers, communication networks between patrons and performers, event listings received by the performer applications, geolocation services for identifying events in real-time, transactions performed between patron applications and performer applications, and any other particular service discussed in further detail herein.

### EXEMPLARY EMBODIMENTS

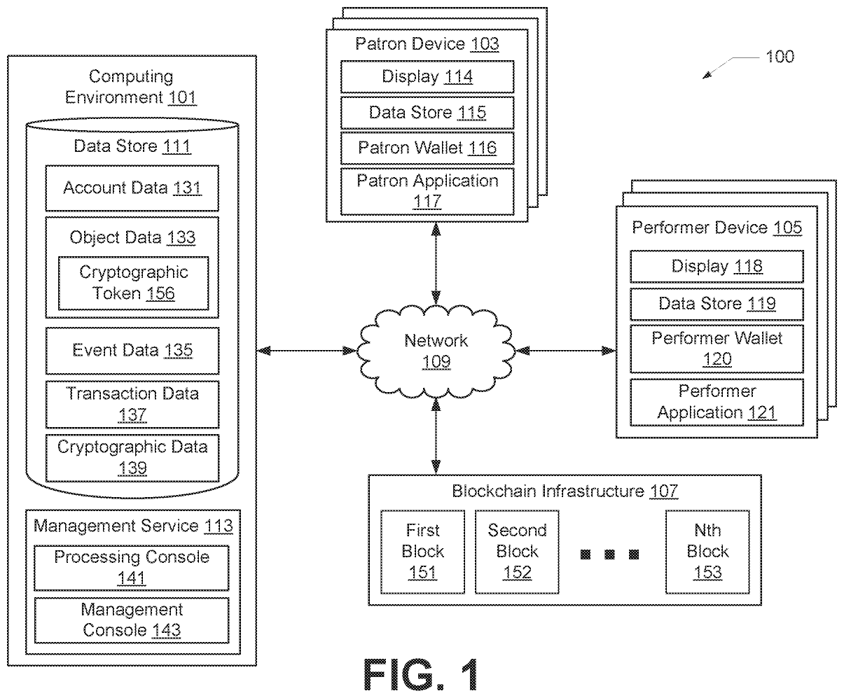

Referring now to the figures, for the purposes of example and explanation of the fundamental processes and components of the disclosed systems and processes, reference is made to FIG. 1, which illustrates an example networked environment 100. As will be understood and appreciated, the networked environment 100 shown in FIG. 1 represents merely one approach or embodiment of the present concept, and other aspects are used according to various embodiments of the present concept.

The networked environment 100 can illustrate an example system for connecting patrons with performers. The patrons can be defined as any particular individual attending an event hosted by the particular performer. The performers can be any particular musician, artist, athlete, and/or other live event entertainment provider that host one or more events. The networked environment 100 can allow communications between patrons attending a particular event and performers hosting the particular event. The networked environment 100 can allow performers and patrons the ability to exchange one or more cryptographic token 156 and other objects based on various different scenarios. For example, the performers can provide, through the networked environment 100, objects (e.g., limited edition tee-shirts) to the first five patrons that attend a particular event. In another example, the networked environment 100 can allow patrons to send tips to the performers in real-time during a particular event.

The networked environment 100 can include a computing environment 101, one or more patron devices 103, one or more performer devices 105, and a blockchain infrastructure 107, which can be in data communication with each other via a network 109. The network 109 can include, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, Bluetooth networks, Wi-Fi networks, NFC networks, and other types of networks.

The computing environment 101 can include, for example, a server computer or any other system providing computing capability. Alternatively, the computing environment 101 can employ more than one computing devices that can be arranged, for example, in one or more server banks or computer banks or other arrangements. Such computing devices can be located in a single installation or can be distributed among many different geographical locations. For example, the computing environment 101 can include one or more computing devices that together can include a hosted computing resource, a grid computing resource, and/or any other distributed computing arrangement. In some cases, the computing environment 101 can correspond to an elastic computing resource where the allotted capacity of processing, network, storage, or other computing-related resources can vary over time.

Various applications and/or other functionality can be executed in the computing environment 101 according to various embodiments. Also, various data can be stored in a data store 111 that is accessible to the computing environment 101. The data store 111 can be representative of one or more of data stores 111 as can be appreciated. The data stored in the data store 111, for example, can be associated with the operation of the various applications and/or functional performers described below.

The components executed on the computing environment 101, for example, can include list of applications, and other applications, services, processes, systems, engines, or functionality not discussed in detail herein. The computing environment 101 can include a management service 113. The management service 113 can function as the central computing module of the computing environment 101. The management service 113 can perform processing aspects of the computing environment 101, the patron devices 103, and/or the performer devices 105. The management service 113 can include a processing console 141 and a management console 143.

The processing console 141 can perform computational requirements of the computing environment 101, the patron devices 103, and/or the performer devices 105. The processing console 141 can, for example, generate cryptographic keys for one or more multi-signature authentication procedures for validating and processing one or more exchanges of one or more cryptographic token 156. In another example, the processing console 141 can analyze event metrics to inform performers on various outcomes associated with the particular event. The processing console 141 can perform statistical analyses and/or computational analyses on the data stored in the data store 111. The processing console 141 can perform one or more functionalities discussed in further detail herein.

The management console 143 can distribute data within the computing environment 101 and/or to other devices located on the network 109. For example, the management console 143 can store data received from the patron device 103 in the data store 111. The management console 143 can transfer data from the data store 111 to the processing console 141. For example, the processing console 141 can request event data 135 from the data store 111 for distribution to one or more patron devices 103. The management console 143 can send and/or receive data to and/or from the patron devices 103, the performer devices 105, the blockchain infrastructure 107, and/or any other resource distributed on the network 109.

The data stored in the data store 111 can include, for example, list of data, and potentially other data. The data store 111 can include an account data 131, an object data 133, an event data 135, a transaction data 137, and a cryptographic data 139.

The account data 131 can include any information associated with the particular patron device 103 and/or the performer device 105. For example, on creating a patron account 401 through the patron device 103, the patron device 103 can send the patron account 401 data to the computing environment 101 for storage in the account data 131. In another example, on creating a performer account (also referred to herein as an event account) through the performer device 105, the performer device 105 can send the performer account data to the computing environment 101 for storage in the account data 131. The account data 131 can include, for example, a patron name, a patron home address, a patron banking information, a patron age, a patron device 103 Media Access Control (MAC) address, a patron device 103 Internet Protocol (IP) address, a patron credit card information, a patron performer preferences, a patron e-mail address, a patron phone number, and/or any other particular information associated with the patron. The account data 131 can include with respect to the performer, for example, a performer name, a performer home address, a performer banking information, a performer age, a performer device 105 Media Access Control (MAC) address, a performer device 105 Internet Protocol (IP) address, a performer credit card information, a performance list, a performer e-mail address, a performer phone number, and/or any other particular information associated with the performer. The account data 131 including the patron account data can be linked to a particular patron device 103. The account data 131 including the performer account data can be linked to a particular performer device 105. The account data 131 associated with the patron account data can be linked to a patron wallet 116. The account data 131 associated with the performer account data can be linked to a performer wallet 120.

The object data 133 can include any data associated with the one or more objects. Objects can be defined as items and/or one or more cryptographic token 156 distributed and exchanged by the performer to one or more patrons to increase patron appreciation for increased interactions with the particular performer. For example, the object data 133 can include any particular list outlining the types of objects for distribution (e.g., specialty tee-shirts, bobble heads, tickets, non-fungible token (NFT) tickets to future and/or exclusive events, NFT trading cards), the types of one or more cryptographic tokens 156 and/or currencies for distribution, the amount of one or more cryptographic tokens 156 and/or currencies for distribution, and/or any particular object used to encourage beneficial patron performer relationships.

The cryptographic token 156 can function as an exchange mechanism for the one or more cryptographic currencies (e.g., StaksCoin). The computing environment 101 can generate cryptographic keys and store the cryptographic keys in the cryptographic data 139. The cryptographic keys can be associated with the particular cryptographic currency. The computing environment can generate the one or more of cryptographic tokens 156 for the particular cryptographic currency using the set of the cryptographic keys. The object can be any exchangeable item that can be distributed between the patron device 103 and the performer device 105 and can function as an award to promote desirable patron-performer behaviors. For example, the award can include a subset of the plurality of cryptographic tokens 156. Continuing this example, the cryptographic tokens 156 can be stored in the patron wallet 116 and/or the performer wallet 120 and can be distributed between the patron device 103 and/or the performer device 105.

The computing environment 101 can generate one or more cryptographic tokens 156 (e.g., cryptographic signatures) for the particular cryptographic currency (e.g., StaksCoin) using the set of the cryptographic keys. The computing environment 101 can employ the authorized approval authorities to generate the cryptographic tokens 156 using the cryptographic keys. For example, the approval authorities can include a subset of patron devices 103, performer devices 105, or a combination thereof. The cryptographic signatures can be generated using RSA encryption protocol, AES encryption, Elliptic Curve Digital Signature Algorithm (ECDSA), or another signature algorithm and authenticating using the cryptographic keys. The computing environment 101 can assign the cryptographic tokens 156 to an administrative wallet corresponding to computing environment 101. The administrative wallet can be part of the computing environment 101. The computing environment 101 can sell the cryptographic tokens 156 in the administrative wallet to one or more patron devices 103 and/or one or more performer device 105. The computing environment 101 can utilize the cryptographic tokens 156 in the administrative wallet to exchange for points from the patron device 103. The computing environment 101 can transfer the cryptographic tokens 156 from the administrative wallet to the patron wallet 116 and/or to the performer wallet 120.

The event data 135 can include any information associated with events and/or performances hosted by the one or more performers. The event data 135 can include, for example, event name, event type, event total capacity, event optimal capacity, event seating arrangement, event location, event venue name, event date, and/or any particular information associated with the event. For example, the vent data 136 can include a data entry that states the name of a musical performance, the location of the musical performance, the capacity of the venue for the music performance, the number of open seats, and the total number of seats.

The transaction data 137 can include data related to transactions performed between one patron device 103 and one performer device 105, one patron device 103 and another patron device 103, one performer device 105 and another performer device 105, the patron device 103 and the computing environment 101, and/or the performer device 105 and the computing environment 101. For example, transaction data 137 can include but is not limited to transaction identification numbers, type of transaction, performer associated with the transaction, patron associated with the transaction, cost of transaction, the date of the transaction, the object associated with the transaction, and/or the cryptographic token 156 associated with the transaction. In various embodiments, a transaction can be defined as an exchange of a proprietary one or more cryptographic tokens 156 (e.g., StaksCoin) or one or more objects between the computing environment 101, the patron device 103, and/or the performer device 105. Transactions can be performed using any particular currency for exchange. For example, the transaction data 137 can include the type of currency used (e.g., credit, debit, cash, money, third party cryptographic tokens 156, proprietary cryptographic tokens 156) and the amount used for the exchange. The transaction data 137 can include one or more exchange rates. The exchange rates can include but are not limited to an exchange rate between StaksCoins and a traditional currency (e.g., United States dollars) or an exchange rate between StaksCoin and third-party cryptographic token 156.

The cryptographic data 139 can include any data associated with authenticating one or more exchanges performed between the patron devices 103, the performer devices 105, and/or the computing environment 101. The cryptographic data 139 can include private keys, public keys, cryptographic signatures, list of fraudulent transactions, list of approved transactions, list of hostile patron devices 103, and/or any other cryptographic information associated with the computing environment 101, the patron devices 103, and/or the performer devices 105. For example, the cryptographic data can include one or more private RSA keys and one or more public RSA keys for generating one or more cryptographic signatures and verifying the one or more generated cryptographic signatures.

The patron device 103 can be representative of a one or more patron devices that can be coupled to the network 109. The patron device 103 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The patron device 103 can include a display 114 for rendering various information on the patron device 103. The display 114 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The patron device 103 can be configured to execute various applications such as a patron application 117 and/or other applications. The patron application 117 can be executed in a client, for example, to access network content served up by the computing environment 101 and/or other servers, thereby rendering a user interface on the display 114. To this end, the patron application 117 can include, for example, a browser, a dedicated application (e.g., a StaksPay application), etc., and the user interface can include a network page, an application screen, etc. The patron device 103 can execute applications beyond the patron application 117 such as, for example, email applications, social networking applications, word processors, spreadsheets, and/or other applications. The patron application 117, for example can render an performance portal of the patron device 103. The performance portal can allow patron device 103 to identify nearby performances based on a geolocation of the patron device 103, edit patron account data and other account data 131, follow performer specific events, exchange one or more cryptographic tokens 156 and/or objects with the performer device 105, and/or tip the performers.

The patron device 103 can include a data store 115. The data store 115 can be substantially similar to the data store 111. The data store 115 can share data with the data store 111 and vise-versa. For example, the data store 115 can be an extension of the data store 111. The data store 115 can include data not stored in the data store 111. For example, the data store 115 can include various private keys local to the patron device 103. In another example, the data store 115 can store the patron wallet 116 locally.

The patron device 103 can include the patron wallet 116 for storing, maintaining, and distributing one or more cryptographic tokens 156 and objects associated with the account data 131 of the specific patron device 103. The patron wallet 116 can be associated to particular account data 131. The patron wallet 116 can function as a multi-signature digital wallet for protecting the one or more cryptographic tokens 156 and ticket NFTs stored within. For example, the computing environment 101 and/or the patron device 103 can implement asymmetric key techniques and algorithms to provide data integrity to sign and authorize transactions associated with the patron wallet 116 (e.g., a cryptographic wallet). To utilize the one or more cryptographic tokens 156 and/or objects held in the patron wallet 116, the patron device 103 can verify submission and validation of multiple cryptographic signatures or keys (e.g., each of which may function as a partial password for any (dis)allowing award point or cryptographic token 156 transactions into or out of the wallet). The multi cryptographic signatures may be required to place a reward (e.g., StaksCoin) into the patron wallet 116. Although illustrated as a component of the patron device 103, the patron wallet 116 can be stored in the computing environment 101, where the computing environment 101 performs maintenance and management of the patron wallet 116.

The performer device 105 can be representative of a one or more performer devices that can be coupled to the network 109. The performer device 105 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The performer device 105 can include a display 118 for rendering various information on the performer device 105. The display 118 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The performer device 105 can be configured to execute various applications such as a performer application 121 and/or other applications. The performer application 121 can be executed in a client, for example, to access network content served up by the computing environment 101 and/or other servers, thereby rendering a user interface on the display 118. To this end, the performer application 121 can include, for example, a browser, a dedicated application, etc., and the user interface can include a network page, an application screen, etc. The performer device 105 can execute applications beyond the performer application 121 such as, for example, email applications, social networking applications, word processors, spreadsheets, and/or other applications. The performer application 121 can allow performers to track metrics associated with performances, track gains associated with performances, track patron engagement, upload new performances, acquire one or more cryptographic tokens 156, list objects and associated thresholds for receiving one or more objects, and/or any particular functionality for allowing the performers to interact with the networked environment 100. The performer application 121 and the patron application 117 can be substantially similar. For example, the patron application 117 and the performer application 121 can be a singular application. Continuing this example, the singular application can render the performer application 121 if the performer device 105 receives performer log in credentials. The singular application can render the patron application 117 if the patron device 103 receives patron log in credentials. The performer application 121 and the patron application 117 can be two distinct applications.

The performer device 105 can include a data store 119. The data store 119 can be substantially similar to the data store 111 and the data store 115. The data store 119 can share data with the data store 111 and the data store 115, and vise-versa. For example, the data store 119 can be an extension of the data store 111. The data store 119 can include data not stored in the data store 111. For example, the data store 119 can include various private keys local to the performer device 105.

The performer device 105 can include the performer wallet 120 for storing, maintaining, and distributing one or more cryptographic tokens 156 and/or objects associated with the object data 133 of the specific performer device 105. The performer wallet 120 can be associated to a particular performer by associated with particular account data 131. The performer wallet 120 can function for the performer device 105 substantially similarly to how the patron wallet 116 functions for the patron device 103.

The blockchain infrastructure 107 can include a distributed ledger system for tracking and recording exchanges performed in the networked environment 100. The blockchain infrastructure 107 can include a public blockchain network (e.g., Bitcoin network, Ethereum network), a private blockchain network, or a hybrid blockchain network. For example, the computing environment 101 can record exchanges of one or more cryptographic tokens 156 between the patron devices 103, the performer devices 105, and/or the computing environment 101 to the Ethereum network as a first block 151. The blockchain infrastructure 107 can include one or more computing devices and one or more memory devices for processing and storing a blockchain ledger. The blockchain ledger can be distributed across the one or more computing devices, which may be located in a single location or different locations. The Blockchain infrastructure 107 can include a second block 152 and an Nth block 153. The second block 152 can illustrate a second exchange recorded on the blockchain infrastructure 107 by the computing environment 101, the patron devices 103, and/or the performer device 105. The Nth block 153 can illustrate that the computing environment 101 can record more than two exchanges onto the blockchain infrastructure 107. In some embodiments, the blockchain infrastructure 107 is incorporated as a component of the computing environment 101.

The computing environment 101 and/or the blockchain infrastructure 107 can record a cryptographic token exchange between the patron device 103 and the performer device 105. For example, the patron device 103 can generate a request to send several StaksCoin as a tip to the performer device 105 in its vicinity (e.g., as detected through Bluetooth or wireless communication). Continuing this example, the computing environment 101 can review the cryptographic data 139 associated with the patron device 103 and approve the transaction. Further continuing this example, the computing environment 101 can approve the transaction and generate the first block 151 to record the tip transfer from the patron wallet 116 of the patron device to the performer wallet 120 of the performer device 105. The performer device 105 can generate a request to send the patron device 103 in its vicinity an object for continued appearances at various performances. For example, the computing environment 101 can review the request by comparing the cryptographic data 139 of the performer device 105 and the respective patron device 103. On approval, the computing device can generate the second block 152 to record the object transfer from the performer wallet 120 to the patron wallet 116. The computing environment 101 can record an assignment of one or more assets (e.g., cryptographic tokens 156 such as StaksCoin, an object, a subscription to a service, or other asset).

In some embodiments, now discussed herein is a general overview of various functionalities of the networked environment 100. In certain embodiments, musicians, athletes, and other live performers, can employ the performer application 121 (or any particular similar musician-specific application) to register their upcoming events. A performer can be any particular individual or group that creates an event for public viewing. For example, the performer can include, but is not limited to, a singer, a band, a street dancer, a magician, an athlete at a meet-and-great, a writer, a theatrical group, a yoga teacher, an educator, a motivational speaker, and a comedian. In certain embodiments, an event (also referred to herein as a performance) is a public or social occasion where a performer presents to at least one or more individuals (also referred to herein as a patrons). For example, an event can include, but is not limited to, a concert, a meet-and-great, an autograph event, a theatrical play, a business conference, a trade show, a game show, a trivia event, a sporting event, and/or any particular performer. In some embodiments, the performer application 121 can request event data 135 when registering events such as location, date, time, performer information (e.g., performer name, number of performers, performer bio, performer age(s)), or any other particular relevant information to the performer). In at least one embodiment, on receiving the event data 135, the performer application 121 can send the event data 135 to the data store 111 of the computing environment 101. On receiving the event data 135 from the performer application 121, the computing environment 101 can store at least one or more performances in the event data 135 and associated the event data 135 with one or more performer device 105.

In particular embodiments, the patron application 117 can include a geolocation portal that displays particular events on a map relative to the current location of the patron device 103. For example, the patron application 117 can employ geolocation technologies onboard the patron device 103 to determine the exact location of the patron device 103. For example, the patron device 103 can include various sensors, such as a global positioning service (GPS) sensor, gyro sensor, near field communication sensors, and/or any other locating sensor that can pinpoint the location of the patron device 103. The patron application 117 can receive the event data 135 from the computing environment 101. The patron application 117 can aggregate the locations of each performance listed in the event data 135 and place them on a geolocation portal of the patron application 117. The patron application 117 can render the geolocation portal as an interactive map on the display 114 of the patron device 103. In some embodiments, the patron application 117 can display the current location of the patron device 103 on the geolocation portal and relative to surrounding events. In one example, the patron application 117 can display a subset of events within a five mile radius of the current location of the patron device 103. The patron application 117 can include a filtered search of performances by varying search radius, filtering by requested music genre, filtering by performance type (e.g., theater show, comedy show, athlete meet-and-greet), and/or any other particular filterable criteria. The patron application 117 can display performer-specific information through the geolocation portal. For example, the geolocation portal can include the interactive map that highlights live performances at specific locations and times. The patron application 117 can surface information associated with the particular performance after receiving an input selecting the particular performance through the patron device 103. The surfaced information can include, but is not limited to, event time, event type, performer name, performer biography, objects, criteria for reaching objects, and/or a link to the performer's full information page. In some embodiments, the computing environment 101, the performer application 121, and/or the patron application 117 can actively query publicly available databases to track events published on other mediums and add the events to an event database of the patron application 117.

Although referred to herein as the performer application 121, the performer device 105 can employ any particular application variations to connects with the patron device 103. Application variations can include, but are not limited to, a StaksAthlete application for connecting athletes to patrons, a StaksMagician application for connecting magicians to patrons, a StaksBusiness application for connecting industry specific individuals to patrons, and a StaksComedian application for connecting comedians with patrons. The patron application 117, the performer application 121, and/or any particular variation of the performer application 121 can be combined as one application (e.g., StaksPay application) or separated into two or more distinct applications. For example, the patron application 117 and the performer application 121 can be two portals within one application. In another example, the patron application 117 and the performer application 121 can be two individual applications using the same computing infrastructure to communicate and perform actions.

In particular embodiments, the performer application 121, the patron application 117, and/or the computing environment 101 can automate the process for consolidating event information within the networked environment 100, providing benefits for patrons and performers, and allowing patrons to discover new performers. For example, the patron application 117 can present tipping options to patrons when in the vicinity of a registered live performance (e.g., as identified by the event data 135). The patron application 117 can determine the location of the patron device 103 using the GPS sensor and identify a nearby performance. Alternatively or in conjunction with using the GPS sensor, the patron device 103 can identify a nearby performer device 105 using any wireless communication protocol. On identifying a nearby performer device 105 and/or performance, the patron application 117 can generate a request to transfer one or more StaksCoin to the identified performer device 105. On approval of the associated cryptographic data 139 by the computing environment 101 associated with the request, the patron device 103 can transfer the one or more StaksCoin from the patron wallet 116 to the performer wallet 120 in real-time.

The patron application 117 can display a list of objects made available by performers. For example, the patron application 117 can present the list of object to the first 100 patron devices 103 that send a tip of a minimum of two cryptographic tokens 156 (e.g., two StaksCoin) to the performer device 105. In certain embodiments, the performer application 121 can change and manage the criteria for receiving a particular objects. In some embodiments, the objects of the patron application 117 and/or the performer application 121 can generate positive patron behaviors (e.g., greater loyalty, increased turnout at performances, increased interactions with the performers online) between patrons and performers. In some embodiments, the patron application 117 can facilitate a direct line of communication between performer devices 105 and patron devices 103 by enabling live requests. For example, the patron application 117 can display a song request leaderboard where patron devices 103 can send vote for requested songs. After a particular period of time, the patron application 117 can forward the top voted song request to the performer application 121 of the particular performer device 105. In some embodiments, the performer application 121 can set a tip amount required for a patron device 103 to generate a live song request. In particular embodiments, if a tip amount sent by the patron application 117 meets a particular threshold and includes a requested song, the performer application 121 can add the request song directly to their performance list.

The patron application 117 and/or the computing environment 101 can employ machine learning and statistical analysis techniques to recommend live performances near a patron device 103 based on previous collected information. For example, the patron application 117 can connect with the music library of the particular patron device 103 and provide performance recommendations based on listening history and performer preferences. In another example, the computing environment 101 can analyze followed performers of a particular patron device 103 and present similar performers to those that the patron follows through the patron application 117.

The computing environment 101 can train the machine learning algorithm using a plurality of historical events, a plurality of historic preferences for a plurality of user accounts, and a plurality of event ratings by individual ones of the plurality of user accounts. The user accounts can be patron user accounts stored in the account data 131 and associated with the patron device 103. The computing environment 101 can train machine learning algorithms on any data gathered by the patron device 103, the performer device 105, and/or the data stored in the data store 111. For example, the computing environment 101 can extract from the event data 135 one or more historical reviews and/or event ratings made by patron device 103 over the last 100 events. Continuing this example, the computing environment 101 can train the machine learning algorithm to generate various recommendations based on the event ratings and the associated text review.

The computing environment 101 can generate one or more recommendations based on the machine learning algorithm. For example, the computing environment 101 can generate switching venues from a first venue to a second venue. The computing environment 101 can employ the machine learning algorithm trained to identify venues with the highest likelihood of tipping being above a specific threshold (e.g., above the mean or above the 75th percentile) from patrons to generate the particular recommendation.

The computing environment 101 can determine preference data for the user account based on a history of electronic activities associated with the user account. The computing environment 101 can gather preferences associated with the patron device 103 from the account data 131, the object data 133, the event data 135, and the transaction data 137. The computing environment can train a machine learning algorithm to recommend events based on the analyzed preference data extracted from the account data 131, the object data 133, the event data 135, and the transaction data 137. For example, the computing environment 101 can generate a respective preference score for each of the list of events for the user account by applying the machine learning algorithm. For example, the performance score can include a “percentage match” identifying the events that have a high likelihood of attracting the patron of the particular patron device 103.

The computing environment 101 is further configured to cause the list of events to be rendered on the patron device 103 in an order based on the respective preference score for each of the list of events for the user account. For example, the patron device 103 can receive the list of events with corresponding preference scores of the events near the geolocation of the patron device 103. Continuing this example, the patron device 103 can render events onto the geolocation portal and show the top rated events first based on the preference score.

In some embodiments, the performer application 121 can facilitate distributing income amongst performance members. The computing environment 101 can receive a tip and income distribution ratio (also referred to herein as a weighting) for split tips amongst performance member and store the tip distribution ration in the account data 131 of associated performer device(s) 105 (e.g., each device of each band member). For example, the computing environment 101 can distribute twenty percent of each tip to each of five performer devices 105 of the five performers in a particular group. In at least one embodiment, the performer application 121 and/or the computing environment 101 can link account data 131 of each performer device 105 of performers in the same group and send tips to the performer wallet 120 of each particular performer device 105.

In particular embodiments, the performer application 121, the patron application 117, and/or the computing environment 101 can perform statistical analysis on gathered data. In one embodiment, the performer application 121 can send an analysis to the performer device 105 for insight into particular aspects of their performances. For example, the patron application 117 can aggregate average time spent at a performers live event by recording location data of the patron device 103. In another example, the performer application 121 can analyze which venues produce the best turnout amongst patrons. The performer application 121 can sort, rank, or filter the venues based on historical turnout. In another example, the performer application 121 can aggregate and analyze data to sort venues based on how many tips are produced for a particular performer. In another example, the performer application 121 can aggregate and analyze data on which times of day produce the most patron turnout and produce the most tips for the performers. The performer application 121 can generate a ranked list of days according patron turnout and/or tips. In some embodiments, the performer application 121 can generate a score for each of the days by weighing the turnout of patrons and the tips for the performer on each day.

In some embodiments, the performer application 121 and/or the patron application 117 can aggregate information on patrons regarding average tips, attendance, and fan engagement at a given venue. Through the network 109 established between the patron application 117 and the performer application 121, patrons can submit feedback to a performer of a live event. For example, the patron application 117 can analyze and report particular words that reflect a generally satisfied patron (e.g., “fun,” “lively,” “happy,” “funny”). In some embodiments, the patron application 117 can record movement of the patron device 103 to see how engaged the patron is with the performance (e.g., are the patrons dancing, are the patrons sitting, are the patrons standing up but not dancing). In some embodiments, the performer application 121 can aggregate a list of top engaged patrons based on the aggregated data and allow performers to communicate with the patrons through the patron application 117 and/or the performer application 121. For example, patron application 117s that send a high volume of tips can receive a communication directly from the performer application 121 of the particular performer. The performer application 121 can send one or more objects to the patron device 103 that send a high volume of tips (e.g., above a percentage or dollar threshold).

In certain embodiments, the performer application 121 can aggregate data on product success (e.g., band specific product). For example, the performer application 121 can notify the performers device 105 if particular products are low in stock. In another example, the performer application 121 can display through the display 118 a live chat with the patron application 117 of nearby patron device 103. The performer application 121 can analyze the live chat and make recommendations for particular actions. The performer application 121, for example, can recommend to turn down the volume if two or more patron application 117 patrons request to lower the volume. In some embodiments, the performer application 121 can upload a track list for the live performance and send the track list to any particular patron application 117 in a specific vicinity to the live performance.

In at least one embodiment, the performer application 121 can provide insights as to how performers are doing amongst one another. For example, the performer application 121 can compare listening time of patrons between two DJs and present the data to the performer device 105. The performer application 121 can create recommendations on how to increase patron engagement for performers in the same space (e.g., changing venues, performing particular songs, recommending a specific time of day for an event).

The patron application 117 can include a share feature. In some embodiments, the share feature can be an option for sending events to friends through the patron application 117. In some embodiments, the patron application 117 can record any events shared by the particular patron device 103. The performer application 121 can be notified of shared events, allowing the performer application 121 to send the patron application 117 of the particular patron one or more object for sharing the event. For example, if the patron application 117 shares an event ten times and ten patron devices 103 are recorded as attend the event, the performer application 121 can send a meet and greet invitation to the patron application 117 of the particular patron device 103 that shared the event.

In some embodiments, the patron application 117 can accept bank and/or credit card information for payment. In at least one embodiment, the patron application 117 can acquire cryptographic tokens 156 (e.g., StaksCoin) for tipping using the bank and/or credit card information provided through the patron application 117. In at least one embodiment, the patron application 117 can facilitate tipping the performer from any place and at any time. The patron application 117 can facilitate tipping for live performances both in person and through streaming platforms.

In particular embodiments, the patron application 117 and the performer application 121 can facilitate increased performer and patron relationships by providing a direct connection of communication between the two parties. For example, the patron application 117 can generate a request to follow the profile of the performer. In certain embodiments, by following the performer through the patron application 117, the patron application 117 can render notifications onto the patron device 103 of upcoming performances and content releases of the followed performer. In at least one or more embodiments, the patron application 117 and the performer application 121 can help facilitate communication between patrons and performers.

In various embodiments, the performer application 121 and the patron application 117 can include the StaksCoin cryptographic token 156. In some embodiments, the patron application 117 can include a Staks marketplace for providing exchangeable objects using the StaksCoin. The Staks marketplace can offer patrons, via the patron application 117, a variety of goods and services that can be exchanged with StaksCoin. The patron application 117 can allow patrons to acquire StaksCoin directly. In some embodiments, the patron application 117 can receive StaksCoins from performer devices 105, other patron devices 103, and or any other particular form of collecting StaksCoin. The Staks marketplace can allow patron devices 103 to acquire objects from particular performers. In some embodiments, the performer application 121 can release limited edition merchandise through the Staks marketplace only accessible to patron devices 103 associated with the particular performer.

In at least one embodiment, the patron application 117 of particular patrons can receive StaksCoins from followed performers or other systems for instigating positive patron behaviors. For example, the performer application 121 of particular performers can receive an initial amount of StaksCoin. The performer application 121 of particular performers can distribute StaksCoins to patron application 117 of patrons that interact with the performers. For example, the performer application 121 can send StaksCoins to patron devices 103 of patrons in response to performing activities like giving tips, attending live events, engaging on social media, and any other metric for patron engagement.

In some embodiments, the value of StaksCoin will be tied to the Staks marketplace and its offerings, along with other programs incorporated into the patron application 117. For example, the patron application 117 can include a StaksRewards system, allowing businesses to offer patrons StaksCoin for customers engaging with the particular business.

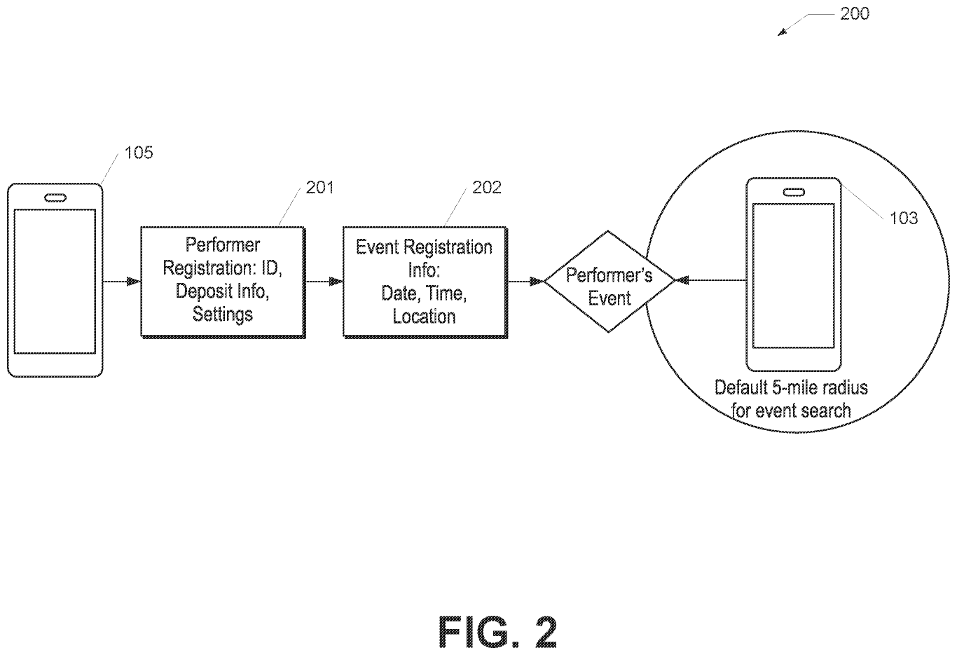

Referring now to FIG. 2, illustrated is a workflow 200 for one or more event registrations according to various embodiments of the present disclosure. In particular embodiments, the performer application 121 and the patron application 117 can facilitate event exposure by providing patrons devices 103 a real-time geolocation system for locating live events. The performer application 121 and the patron application 117 can be combined to provide performers and patrons a centralized platform for supporting performers, connecting performers to patrons, establishing patron engagement programs, offering objects, gathering data regarding patrons and performers, providing event ticket for exchange, creating a feedback environment, managing yield from events, and any other relevant feature for patron and performer interactions.

The performer device 105 can receive an installation of the performer application 121. On downloading the performer application 121, the performer device 105 can employ the performer application 121 to generate a registration 201 from the particular performer. In at least one embodiment, the performer application 121 can receive the registration 201 from the performer. The registration 201 received by the performer application 121 can include performer identification information (e.g., group name, group size, performance category/type, age(s), city of residence), deposit accounts for payments, and settings preferences (e.g., tip distribution ratio, income distribution ratio, publication settings, data analytics settings). In particular embodiments, the computing environment 101 can receive the registration 201 sent by the performer application 121 and store the registration into the account data 131. The computing environment 101 can create the performer account based on the registration 201 information. Once the performer account is recorded by the computing environment 101, the performer application 121 can register upcoming events of the particular performer. For example, the performer application 121 can receive event information including date, time, location, venue name, event type, and/or any other information pertinent to describing the particular event.

The patron device 103 can receive a request to download and install the patron application 117. The patron application 117 can prompt the patron to create the patron account 401. On receiving a patron account 401 registration, the patron application 117 can provide the patron access to features for connecting patrons and performers. For example, the patron application 117 can include the interactive map that actively connects patrons to known events on a real-time basis. The computing environment 101 can consolidate a list of events received by the performer application 121 as the event data 135. The computing environment 101 can send the event data 135 to the patron application 117. The patron application 117 can use onboard geolocation techniques to locate the patron on the interactive map. The patron application 117 can provide render the interactive map that illustrates various events relative to the current location of the patron device 103. For example, the patron application 117 can search and render events in a default 5-mile radius relative to the patron device 103. In another example, the patron application 117 can receive a search request to highlight particular events near the patron device 103. The patron application 117 can filter the search by providing selectable criteria to narrow the search parameters (e.g., genre, event size, event type, opening and closing times, proximity to patron, and/or proximity to public transportation). The patron application 117 can detect/identify registered events in a particular radius created through the performer application 121 or any other related application and present it to the patron with pertinent information (e.g., venue, artist).

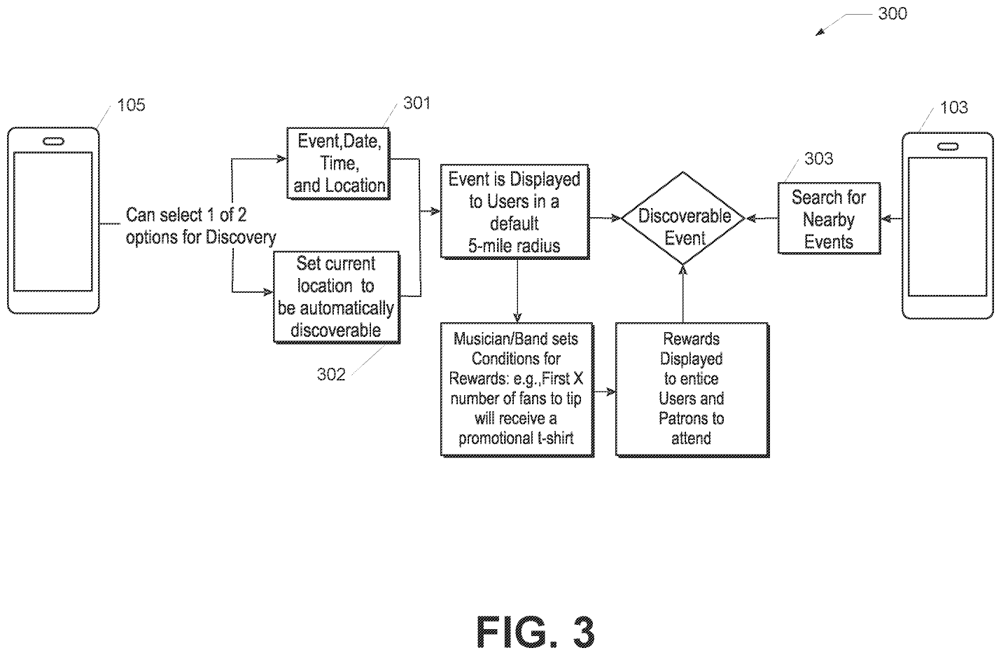

Referring now to FIG. 3, illustrated is a workflow 300 for event discovery and facilitating positive interactions between patrons and performers, according to one embodiment, of the present disclosure. In some embodiments, the patron application 117 and the performer application 121 can interact to provide patrons with objects based on real-time interaction with particular performers.

The performer application 121 can receive one or more discovery settings. In at least one embodiment, the discovery settings can include one or more discovery options. For example, a first discovery option 301 can include the performer application 121 using registration information of the performer's event (e.g., specific venue/location, the date, time of performance) to identify the current location of the particular event. The performer application 121 and/or the computing environment 101 can send the location of the upcoming or current event to the patron application 117 of nearby patrons. In another example, a second discovery option 302 can include the performer application 121 using onboard geolocation technologies of the performer device 105 to provide real-time location information of the particular performers to the patron device 103. The performer application 121 can forward this information to the patron application 117 of nearby patron devices 103 to provide real-time locations of particular performers. After the performer application 121 applies a particular discovery setting, the patron application 117 can render the event through the display 114 of patron devices 103 within a 5-mile radius. In particular embodiments, the default radius can be changed to any particular radius. In some embodiments, the location of the patron can be changed to provide real-time information on locations distinct form the patron device 103. For example, before traveling to a new city for vacation, the patron application 117 can show future events in the particular city through the patron device 103.

To assist with patron retention and discovery, the performer application 121 can create objects associated with events to generate positive interactions with patrons. The object can be any item made available by the patron device 103 to stimulate recognition, excitement, and/or any positive outcome for the particular performer. The performer application 121 can recommend patron applications 117 one or more objects along with particular conditions for receiving said objects. The performer application 121 can provide the objects to patron device 103 when the patron devices 103 reach the associated condition. For example, the first finite number of patron device 103 to send a tip to the performer device 105 at a particular event will receive a limited edition t-shirt. In another example, the first number of new patron devices 103 that stay in the vicinity of the performance for an hour or longer will receive a StaksCoin from the performer device 105. The computing environment 101 can receive the conditions along with their associated object. The performer application 121 and/or the computing environment 101 can send the objects and associated conditions to the patron application 117. The patron application 117 can present the conditions and associated objects to the patron through the performance portal. The patron application 117 can render the performance portal in combination with the geolocation portal to identify one or more performances. In some embodiments, the patron application 117 in real-time, after, and/or before presents the objects associated with particular events to the patron device 103. The patron application 117 can present live events through the performance portal along with information associated with the event (e.g., date, time, location, objects, performers, event description, and/or conditions for receiving the object). In some embodiments, the performer application 121 can toggle an automatic discovery setting that automatically presents patrons with the performer's events through the patron application 117. The patron application 117 can generate a search feature 303 for searching nearby events.

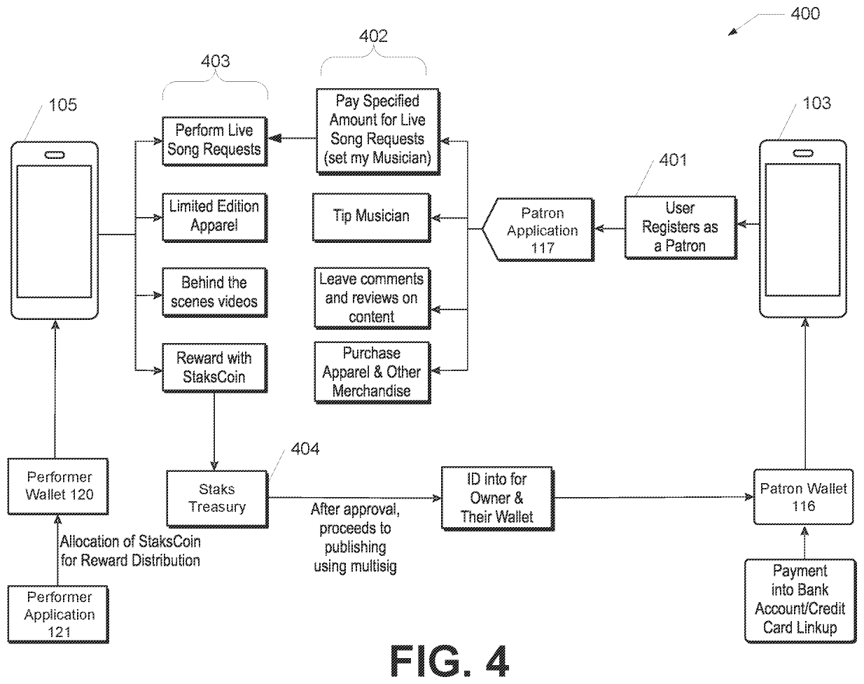

Referring now to FIG. 4, illustrated is a workflow 400 for engaging with patrons through the networked environment 100 according to various embodiments of the present disclosure. The patron application 117 can create and manage the patron wallet 116 after creating and registering the patron account 401. The patron wallet 116 can be a blockchain-enabled wallet (e.g., through the blockchain infrastructure 107) created for each particular patron device 103 and can be used for distributing and storing cryptocurrencies, NFTs, and/or any particular blockchain based tradable good. In certain embodiments, the patron wallet 116 can accept payment information including bank account and/or credit card information. Once the payment information is added and accepted and the patron device 103 registers as a patron, the patron application 117 can allow the patron to interact with the performers and/or any other particular service in the patron application 117. The patron application 117 can generate one or more patron interactions 402. For example, the patron application 117 can generate a tip request to send the performer device 105 one or more StaksCoin. In another example, the patron application 117 can render a comment section for receiving comments and reviews for content released by the performer. In another example, the patron application 117 can facilitate acquiring apparel & other merchandise from the performers.

The performer application 121 can allow performers to interact with the patrons through the patron application 117. For example, the patron application 117 can prompt a “Follow” setting. When the Follow setting is enabled for a specific performer, the patron application 117 can list the patron device 103 as a supporter of the performer. In some embodiments, the patron application 117 can present patrons with performer generated content 403 from their followed performers (e.g., early ticket access, exclusive merchandise, private events). For example, the performer application 121 can send notifications associated with limited edition apparel to the patron application 117. In another example, the performer application 121 can send special behind-the-scenes videos of their production to patron application 117. In another example, the performer application 121 can access the performer wallet 120 to send StaksCoin to the patron application 117 of patrons of the particular performer.

In at least one embodiment, a Staks treasury 404 processes a transaction between one or more patron wallets 116 and/or one or more performer wallets 120. The Staks treasury 404 can process blockchain transactions using StaksCoin and/or a debit/credit card by recording the transaction to the blockchain infrastructure 107. The Staks treasury 404 can be integrated into the processing console 141 and can employ the cryptographic data 139 to approve transactions. For example, the Staks treasury 404 can process the debit/credit card exchange of a particular amount of StaksCoin and convert the dollar amount to StaksCoin. On completing the StaksCoin exchange, a specific amount of StaksCoin can be added into the patron wallet 116 of the patron application 117. In some embodiments, each registered account can include an associated Staks treasury. In certain embodiments, the Staks treasury manages the yield produced from object exchange, exchanging StaksCoin, tips, and/or any particular action affecting yield of the patrons and/or the performers.

In particular embodiments, after a transaction is approved by the Staks treasury 404 using the cryptographic data 139, the patron application 117 and/or the performer application 121 publishes the tradable good (e.g., StaksCoin, NFTs) to the patron wallet 116 using a multi-signature security method. In at least one embodiment, the patron wallet 116 of registered patrons and the performer wallet 120 of registered performers can utilize multi-signature authentication frameworks for validating and processing transactions relating to StaksCoin, NFTs, and/or any blockchain-enabled tradable good. In at least one embodiment, the computing environment 101 can maintain multi-signature digital wallets (e.g., the patron wallet 116 and the performer wallet 120) for storing StaksCoin and can record transactions performed between the performer application 121 and the patron application 117 as transaction data 137. The computing environment 101 can implement asymmetric key techniques and algorithms to provide data integrity to sign and authorize transactions associated with the patron wallet 116 and the performer wallet 120. In various embodiments, to utilize assets held in the patron wallet 116 and the performer wallet 120, the computing environment 101 can require submission and validation multiple cryptographic signatures or keys (e.g., each of which may function as a partial password for any StaksCoin transactions into or out of the patron wallet 116). The multiple cryptographic signatures can be approved by the same authority or each cryptographic signature can be approved by a different approval authority. The multi cryptographic signatures may be required to exchange StaksCoin and/or tipping performers using StaksCoin. In one embodiment, the computing environment 101 can require authentication of two cryptographic signatures in order to initiate transactions for the patron wallet 116 and the performer wallet 120. In one embodiment, the computing environment 101 can receive a first cryptographic signature and a second cryptographic signature from a first online portal and a second online portal to process a patron's request to tip a performer using StaksCoin. In some embodiments, the first online portal can be associated with a first approval authority and the second online portal can be associated with a second approval authority that may be unaffiliated with the first approval authority.

In various embodiments, once the multi-signature process is approved, the patron wallet 116 of the particular patron device 103 can receive exchanged StaksCoin. In another example, after the multi-signature process is approved for a tip transaction, the performer wallet 120 of the particular performer device 105 can receive a StaksCoin from the patron wallet 116 of the particular patron device 103. In some embodiments, the performer application 121 communicating with the patron application 117 can allow performers and other entertainment providers the ability to provide their patrons various objects for their contributions and engagements with the particular performers.

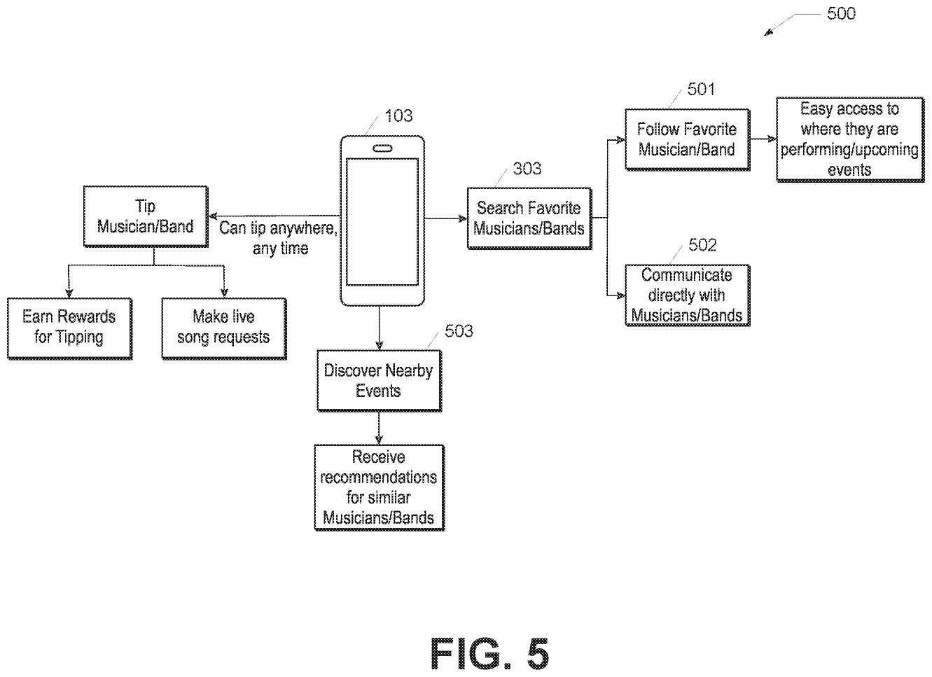

Referring now to FIG. 5, illustrated is a workflow 500 showing various features of the patron application 117, according to one embodiment of the present discourse. In particular embodiments, the patron application 117 can present the patron a variety of features for discovering and interacting with performers. For example, the patron application 117 can provide the search feature 303 to receive a search request for the favorite performers of the patron. The patron application 117 can include a follow feature 501 for generating and sending a follow request to the performer device 105. Once the patron application 117 records the follow request for the particular performer, the patron application 117 can generate notifications for new content and upcoming events associated with the particular performer. In some embodiments, the patron application 117 can include a communication channel 502 for establishing a communication between the patron application 117 and the performer application 121. For example, the patron application 117 can include a chat interface where patrons devices 103 can communicate with the performer devices 105 by sending messages from the patron application 117 to the performer application 121. In particular embodiments, the patron application 117 can form communication networks with other patron devices 103 to allow patrons to communicate between one another. In at least one embodiment, the patron application 117 can include the geolocation portal. The geolocation portal can facilitate event discovery 503. For example, the patron application 117 can render the interactive map with a real-time location of the patron device 103 relative to nearby events listed by the performer application 121. In another example, the patron application 117 will generate recommendations on local events near the patron device 103 that are similar to the patron's followed performers. The patron application 117 can facilitate tipping performers from any particular location at any particular time. In certain embodiments, the performer application 121 can facilitate an exchange systems between the performer application 121 and the patron application 117.

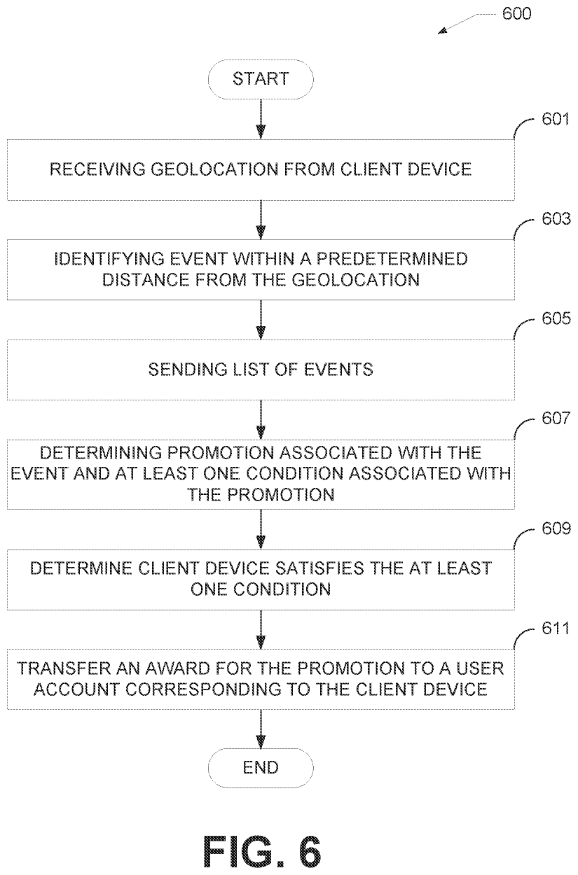

Referring now to FIG. 6, illustrated is a flowchart of a process 600 according to various embodiments of the present disclosure. The process 600 can illustrate a technique for identifying one or more events near the patron device 103, determining a promotion associated with the one or more events, and receiving the particular promotion. In some embodiments, the promotion can be substantially similar to the objects.

At box 601, the process 600 can include receiving a geolocation from the patron device 103 (also referred to herein as a client device), the geolocation corresponding to a location of the patron device 103. The computing environment 101 can receive the geolocation from the patron device 103, where the geolocation corresponding to the location of the patron device 103. The patron device 103 can include various location identifying sensors. For example, the patron device 103 can include but is not limited to the GPS sensor, the gyro sensor, and a direction sensor. The patron device 103 can send the computing environment 101 the data generated by the location identifying sensors. The computing environment 101 can repeatedly request and/or receive the geolocation from the patron device 103 to identify the location of the patron device 103 in real-time.

At box 603, the process 600 can include identifying the event within a predetermined distance from the geolocation. The computing environment 101 can identify the event within the predetermined distance from the geolocation. The computing environment 101 can access event data 135 to identify the location of each particular event and/or performance. The computing environment 101 can compare the location of each particular even to the geolocation of the patron device 103. The computing environment 101 can calculate the distance between the geolocation of the patron device 103 and the location of the event as recorded in the event data 135. The computing environment can determine if the distance between the geolocation of the patron device 103 and the location of the event based on the event data 135 falls within the predetermined distance. The computing environment 101 can generate a list of events that fall within the predetermined distance. The computing environment 101 can repeatedly update the list of event that fall within the predetermined distance based on any movements of the patron device 103.

At box 605, the process 600 can include sending the list of events comprising the event to the patron device 103. The computing environment 101 can send the list of events comprising the event to the patron device 103. The computing environment 101 can send the list of events to the patron device 103 over the network 109.

At box 607, the process 600 can include determining the promotion associated with the event and at least one condition associated with the promotion. The computing environment 101 and/or the patron device 103 can determine the promotion associated with the event and at least one condition associated with the promotion. The patron device 103 can request a list of objects and/or promotions associated with the event from the computing environment 101. The patron device 103 can identify one or more promotions by extracting the list of objects and/or promotions from the object data 133. The object data 133 extracted from the data store 111 can be associated with the account data 131 of one or more performer devices 105 that registered the one or more events within the predetermined distance. The computing environment 101 can send the patron device 103 the list of objects and/or promotions that are associated with the events within the predetermined distance. The patron device 103 can render the list of objects and/or promotions and can generate a request to redeem a particular promotion.

At box 609, the process 600 can include determining that the patron device 103 satisfies the at least one condition associated with the promotion. The computing environment 101 can determine that the patron device 103 satisfies the at least one condition associated with the promotion. The computing environment 101 can extract one or more conditions for associated with the list of objects and/or promotions. The conditions can include but are not limited to a number of tips sent, a tipping frequency, a tipping amount, a time spent at the performance, and the amount of shares sent by the patron device 103. The patron device 103 can send various data and/or electronic activity to the computing environment 101. The computing environment 101 can determine if the at least one condition is met based on the data and the electronic activities received from the patron device 103. For example, the computing environment 101 can analyze the geolocation of the patron device 103. In the case that the promotion includes a condition to stay at the performance for more than one hour, the computing environment 101 can check the geolocation data of the patron device 103 to verify the patron device 103 satisfies the at least one condition.

At box 611, the process 600 can include in response to determining that the client device satisfies the at least one condition, transfer an award for the promotion to a user account corresponding to the client device. in response to the computing environment 101 determining that the patron device 103 satisfies the at least one condition, performer device 105 and/or the computing environment 101 can transfer an object (also referred to herein as an award) for the promotion to the patron account 401 corresponding to the patron device 103. The computing environment 101 can transfer the award from the performer device 105 to the patron device 103. For example, the computing environment 101 can initiate a multi-signature authentication of the patron wallet 116 and/or the performer wallet 120. On approving the authentication of the patron wallet 116 and/or the performer wallet 120, the computing environment 101 can grant the transfer of digital assets between the patron wallet 116 and/or the performer wallet 120. For example, the computing environment 101 can facilitate an exchange of 5 StakCoin from the performer wallet 120 to the patron wallet 116. The computing environment 101 can record the transaction between the patron device 103 and the performer device 105 on the blockchain infrastructure 107.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such non-transitory computer-readable media can comprise various forms of data storage devices or media such as RAM, ROM, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The processing unit can include one or more hardware processors. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A patron may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are example and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. The steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the example embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the example embodiments described therein.
Clause 1. A system, comprising: a data store; and at least one computing device in communication with the data store, the at least one computing device being configured to: receive a geolocation from a client device, the geolocation corresponding to a location of the client device; identify an event within a predetermined distance from the geolocation; send a list of events comprising the event to the client device; determine a promotion associated with the event and at least one condition associated with the promotion; determine that the client device satisfies the at least one condition associated with the promotion; and in response to determining that the client device satisfies the at least one condition, transfer an award for the promotion to a user account corresponding to the client device.
Clause 2. The system of clause 1 or any other clause, wherein the at least one computing device is further configured to: train a machine learning algorithm using a plurality of historical events, a plurality of historic preferences for a plurality of user accounts; and a plurality of event ratings by individual ones of the plurality of user accounts; determine preference data for the user account based on a history of electronic activities associated with the user account; and generate a respective preference score for each of the list of events for the user account by applying the machine learning algorithm.
Clause 3. The system of clause 2 or any other clause, wherein the at least one computing device is further configured to cause the list of events to be rendered on the client device in an order based on the respective preference score for each of the list of events for the user account.
Clause 4. The system of clause 1 or any other clause, wherein the at least one computing device is further configured to: generate a set of cryptographic keys associated with a particular cryptographic currency; and generate a plurality of cryptographic tokens for the particular cryptographic currency using the set of the cryptographic keys, wherein the award comprises a subset of the plurality of cryptographic tokens.
Clause 5. The system of clause 4 or any other clause, wherein the at least one computing device is further configured to transfer the award for the promotion by recording an assignment of the subset of the cryptographic tokens on a block chain.
Clause 6. The system of clause 1 or any other clause, wherein the at least one computing device is further configured to: receive a request to tip a count of cryptographic tokens to an event account from the client device; and transfer the count of cryptographic tokens from the user account to the event account in response to the request.
Clause 7. The system of clause 6 or any other clause, wherein the event account comprises a plurality of event accounts and the at least one computing device is further configured to: determine a plurality of weightings individually corresponding to a respective one of the plurality of event accounts, wherein a sum of the plurality of weightings is equal to one; and transfer the count of the cryptographic tokens into the plurality of event accounts divided according to the plurality of weightings.
Clause 8. The system of clause 6 or any other clause, wherein the at least one condition associated with the promotion is satisfied in response to tipping the count of cryptographic tokens.
Clause 9. A method, comprising: receiving, via one of one or more computing devices, a geolocation from a client device, the geolocation corresponding to a location of the client device; identifying, via one of the one or more computing devices, an event within a predetermined distance from the geolocation; sending, via one of the one or more computing devices, a list of events comprising the event to the client device; determining, via one of the one or more computing devices, a promotion associated with the event and at least one condition associated with the promotion; determining, via one of the one or more computing devices, that the client device satisfies the at least one condition associated with the promotion; and in response to determining that the client device satisfies the at least one condition, award a user account corresponding to the client device with an award for the promotion.
Clause 10. The method of clause 9 or any other clause, further comprising: generating, via one of the one or more computing devices, a list of upcoming events corresponding to an entity hosting the event; and causing, via one of the one or more computing devices, the list of upcoming events to be rendered on the client device.
Clause 11. The method of clause 9 or any other clause, further comprising monitoring, via one of the one or more computing devices, electronic activities on the client device, wherein the client device satisfying the at least one condition is determined based on the electronic activities.
Clause 12. The method of clause 11 or any other clause, wherein monitoring the electronic activities comprises monitoring the geolocation of the client device to determine whether the client device enters into a threshold distance from a location of the event.
Clause 13. The method of clause 9 or any other clause, further comprising causing, via one of the one or more computing devices, the event to be rendered at an event location on a map on a display of the client device.
Clause 14. The method of clause 9 or any other clause, wherein the event corresponds to a particular entity and the promotion is provided by the particular entity.
Clause 15. A non-transitory computer-readable medium embodying a program that, when executed by at least one computing device, causes the at least one computing device to: receive a geolocation from a client device, the geolocation corresponding to a location of the client device; identify an event within a predetermined distance from the geolocation; send a list of events comprising the event to the client device; determine a promotion associated with the event and at least one condition associated with the promotion; determine that the client device satisfies the at least one condition associated with the promotion; and in response to determining that the client device satisfies the at least one condition, transfer an award for the promotion to a user account corresponding to the client device.
Clause 16. The non-transitory computer-readable medium of clause 15 or any other clause, wherein the program further causes the at least one computing device to: receive an event specific request from the client device; determine at least one cost associated with the event specific request; and in response to completion of the at least one cost, send a request for the event specific request to be performed to an event organizer account.
Clause 17. The non-transitory computer-readable medium of clause 16 or any other clause, wherein the event specific request comprises a request for a particular song and the program further causes the at least one computing device to send the request for the event specific request to be performed by adding the particular song to a performance list for the event.
Clause 18. The non-transitory computer-readable medium of clause 16 or any other clause, wherein the program further causes the at least one computing device to transfer at least one cryptographic token from the user account to the event organizer account to complete the at least one cost.
Clause 19. The non-transitory computer-readable medium of clause 18 or any other clause, wherein the at least one cryptographic token comprises a StaksPay token.
Clause 20. The non-transitory computer-readable medium of clause 16 or any other clause, wherein the program further causes the at least one computing device to: surface information related to the event; and transmit the information to the client device.

These and other aspects, features, and benefits of the claimed innovation(s) will become apparent from the following detailed written description aspects taken in conjunction with the following drawings, although variations and modifications thereto may be effected without departing from the spirit and scope of the novel concepts of the disclosure.

What is claimed is:

1. A system, comprising:
a data store; and
at least one computing device in communication with the data store, the at least one computing device being configured to:
receive a geolocation from a client device, the geolocation corresponding to a location of the client device;
identify an event within a predetermined distance from the geolocation;
send a list of events comprising the event to the client device;
determine a promotion associated with the event and at least one condition associated with the promotion;
determine that the client device satisfies the at least one condition associated with the promotion; and
in response to determining that the client device satisfies the at least one condition, transfer an award for the promotion to a user account corresponding to the client device.

2. The system of claim 1, wherein the at least one computing device is further configured to:
train a machine learning algorithm using a plurality of historical events, a plurality of historic preferences for a plurality of user accounts; and a plurality of event ratings by individual ones of the plurality of user accounts;
determine preference data for the user account based on a history of electronic activities associated with the user account; and
generate a respective preference score for each of the list of events for the user account by applying the machine learning algorithm.

3. The system of claim 2, wherein the at least one computing device is further configured to cause the list of events to be rendered on the client device in an order based on the respective preference score for each of the list of events for the user account.

4. The system of claim 1, wherein the at least one computing device is further configured to:
generate a set of cryptographic keys associated with a particular cryptographic currency; and
generate a plurality of cryptographic tokens for the particular cryptographic currency using the set of the cryptographic keys, wherein the award comprises a subset of the plurality of cryptographic tokens.

5. The system of claim 4, wherein the at least one computing device is further configured to transfer the award for the promotion by recording an assignment of the subset of the cryptographic tokens on a block chain.

6. The system of claim 1, wherein the at least one computing device is further configured to:
receive a request to tip a count of cryptographic tokens to an event account from the client device; and
transfer the count of cryptographic tokens from the user account to the event account in response to the request.

7. The system of claim 6, wherein the event account comprises a plurality of event accounts and the at least one computing device is further configured to:
determine a plurality of weightings individually corresponding to a respective one of the plurality of event accounts, wherein a sum of the plurality of weightings is equal to one; and
transfer the count of the cryptographic tokens into the plurality of event accounts divided according to the plurality of weightings.

8. The system of claim 6, wherein the at least one condition associated with the promotion is satisfied in response to tipping the count of cryptographic tokens.

9. A method, comprising:
receiving, via one of one or more computing devices, a geolocation from a client device, the geolocation corresponding to a location of the client device;
identifying, via one of the one or more computing devices, an event within a predetermined distance from the geolocation;
sending, via one of the one or more computing devices, a list of events comprising the event to the client device;
determining, via one of the one or more computing devices, a promotion associated with the event and at least one condition associated with the promotion;
determining, via one of the one or more computing devices, that the client device satisfies the at least one condition associated with the promotion; and
in response to determining that the client device satisfies the at least one condition, award a user account corresponding to the client device with an award for the promotion.

10. The method of claim 9, further comprising:
generating, via one of the one or more computing devices, a list of upcoming events corresponding to an entity hosting the event; and
causing, via one of the one or more computing devices, the list of upcoming events to be rendered on the client device.

11. The method of claim 9, further comprising monitoring, via one of the one or more computing devices, electronic activities on the client device, wherein the client device satisfying the at least one condition is determined based on the electronic activities.

12. The method of claim 11, wherein monitoring the electronic activities comprises monitoring the geolocation of the client device to determine whether the client device enters into a threshold distance from a location of the event.

13. The method of claim 9, further comprising causing, via one of the one or more computing devices, the event to be rendered at an event location on a map on a display of the client device.

14. The method of claim 9, wherein the event corresponds to a particular entity and the promotion is provided by the particular entity.

15. A non-transitory computer-readable medium embodying a program that, when executed by at least one computing device, causes the at least one computing device to:
receive a geolocation from a client device, the geolocation corresponding to a location of the client device;
identify an event within a predetermined distance from the geolocation;
send a list of events comprising the event to the client device;
determine a promotion associated with the event and at least one condition associated with the promotion;
determine that the client device satisfies the at least one condition associated with the promotion; and
in response to determining that the client device satisfies the at least one condition, transfer an award for the promotion to a user account corresponding to the client device.

16. The non-transitory computer-readable medium of claim 15, wherein the program further causes the at least one computing device to:
receive an event specific request from the client device;
determine at least one cost associated with the event specific request; and
in response to completion of the at least one cost, send a request for the event specific request to be performed to an event organizer account.

17. The non-transitory computer-readable medium of claim 16, wherein the event specific request comprises a request for a particular song and the program further causes the at least one computing device to send the request for the event specific request to be performed by adding the particular song to a performance list for the event.

18. The non-transitory computer-readable medium of claim 16, wherein the program further causes the at least one computing device to transfer at least one cryptographic token from the user account to the event organizer account to complete the at least one cost.

19. The non-transitory computer-readable medium of claim 18, wherein the at least one cryptographic token comprises a StaksPay token.

20. The non-transitory computer-readable medium of claim 16, wherein the program further causes the at least one computing device to:
surface information related to the event; and
transmit the information to the client device.
